(19) United States
(12) Patent Application Publication
(10) Pub. No.: US 2026/0303467 A1
(43) Pub. Date: Oct. 1, 2026

(54) SYSTEM AND METHOD FOR REAL-TIME NETWORK VIEW USING SITES AND COVERAGE VIEW

(71) Applicant: JIO PLATFORMS LIMITED, Ahmedabad (IN)

(72) Inventors: Aayush BHATNAGAR, Navi Mumbai (IN); Pradeep Kumar BHATNAGAR, Navi Mumbai (IN); Sundaresh SANKARAN, Kanjurmarg West, Mumbai (IN); Haresh B AMBALIYA, Bhundani, Gujarat (IN); Sandeep RAWAT, Uttarakhand (IN); Preetam SAHU, Pundag, Ranchi (IN); Vikram SINGH, Navi Mumbai (IN)

(73) Assignee: JIO PLATFORMS LIMITED, Ahmedabad (IN)

(21) Appl. No.: 18/880,397

(22) PCT Filed: Jun. 3, 2024
(86) PCT No.: PCT/IN2024/050668

§ 371 Date: Dec. 31, 2024

(30) Foreign Application Priority Data
Jun. 28, 2023 (IN) 202321043265

(51) Int. Cl. H04L 41/14; H04L 43/08

(52) U.S. Cl. CPC H04L 41/145; H04L 43/08

(57) ABSTRACT

The present invention discloses a system (108) and method (300) for creating a real-time network view using cellular sites and coverage layers. In modern telecommunications networks, users provide services through various types of nodes utilizing different technologies. The system introduces a digitized view in the form of a map layer, enabling streamlined operations and enhanced efficiency. Also, the system leverages web-based platforms to generate a real-time network view comprising site layer view or coverage layer views. This digitized representation allows users to easily monitor, assess, and analyze their networks. By creating a network view that gets updated automatically, the system eliminates a need to collect and maintain site layer data and create heatmaps.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to the field of cellular technology. More particularly, the present disclosure relates to a system and a method that provides a real-time view of network in terms of site and coverage to assist engineers in planning and optimization of any live network.

### DEFINITION

As used in the present disclosure, the following terms are generally intended to have the meaning as set forth below, except to the extent that the context in which they are used to indicate otherwise.

The expression ‘coverage layer (or heatmap) view’ used hereinafter in the specification refers to a 2-dimensional data visualization technique that represents the magnitude of individual values within a dataset as a color. The variation in color may be by hue or intensity. In the present disclosure, the coverage layer view may be generated in view of RSRP (reference signal receive power), SINR (signal to interference ration), downlink throughput, uplink throughput, and Best Server plot.

The expression ‘scheduling time’ used hereinafter in the specification refers to a specific block of time at a request need to be executed.

The expression ‘sub-layer option’ used hereinafter in the specification refers a feature or functionality within a user interface (UI) that allows users to manipulate or control a specific layer of content or functionality that lies beneath a primary interface layer.

The expression ‘Best Server Plot (BSP)’ used hereinafter in the specification refers to a visual representation of a predicted best server (base station) that a mobile device would connect to at each location within a defined area. The BSP is a graphical representation of server performance, often used in computer systems and networks to monitor and analyze network traffic and identifying bottlenecks. The plot provides insights into server response time, throughput, and resource usage, helping IT professionals optimize server configurations, identify potential issues, and prevent downtime.

The expression ‘Uplink (UL) throughput’ used hereinafter in the specification refers to an amount of data transmitted from a user device, such as a smartphone or computer, to a cellular tower. This measure of performance is typically reported in bits per second (bps) and represents the rate at which data is uploaded from the device to the network.

The expression ‘Downlink (DL) throughput’ used hereinafter in the specification refers to an amount of data received by a user device from a cellular tower. It is used to measure the speed and efficiency of internet connections, especially in mobile environments where device capabilities, signal strength, and network traffic can impact network performance.

These definitions are in addition to those expressed in the art.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

A telecommunications network consists of nodes (network sites) connected by links, such as traditional switching nodes, packet routers, or versatile router-switches. Analysis of the network sites is critical for network design, impacting efficiency, reliability, and performance of the telecommunication network.

Understanding a network's layout is crucial for addressing disruptions and planning enhancements, but manual determination becomes challenging with a growing number of nodes. Additionally, detecting and resolving malfunctions in interconnected nodes becomes more complex as their count increases. In conventional approach to network analysis, teams responsible for managing networks manually handle lists of sites and perform manual efforts to create layers that can be plotted on maps using desktop-based tools. Similarly, engineers use desktop-based tools to generate coverage heatmaps. However, this manual process becomes arduous and impractical when dealing with large geographic areas or when real-time network views are required.

The existing manual approach to creating a network view proves to be inefficient and time-consuming, making it difficult to maintain an up-to-date and accurate representation of the network. Network users face significant challenges in managing and monitoring their networks effectively using traditional methods, especially as networks expand and the number of nodes increases.

There is, therefore, a need in the art to provide a system and a method that can mitigate the problems associated with the prior arts.

### OBJECTS OF THE INVENTION

It is an object of the present disclosure to provide a system and a method that eliminates need for manual data collection and maintenance by automating the process of creating and updating the network view and provides real-time updates to the site layer and heatmap layer, ensuring that the network view reflects the current state of the network accurately.

It is an object of the present disclosure to provide a system and a method that significantly reduces the effort required to collect and maintain data for the site layer and heatmap layer, and users can focus their resources on other critical tasks instead of spending time on manual data management.

It is an object of the present disclosure to provide a system and a method that implements a map layer view of sites and coverage, presenting the network view in an intuitive and visual manner, and this digitized representation on a map interface simplifies the understanding of the network layout, site distribution, and coverage areas.

It is an object of the present disclosure to provide a system and a method that enables efficient network analysis by providing a user-friendly web interface for viewing the network, and the user to easily analyze the network's performance, identifies coverage gaps, and makes informed decisions for network optimization.

It is an object of the present disclosure to provide a system and a method that facilitates geospatial analysis by providing a comprehensive view of live sites in the network and their coverage. Users can perform spatial analysis, and assess network performance in

It is an object of the present disclosure to provide a system and a method that is applicable to various generations of mobile technology, including 2G, 3G, 4G, 5G, and beyond. It also supports networks with multiple technology vendors, allowing users to manage diverse network infrastructures efficiently.

It is an object of the present disclosure to provide a system and a method that handles networks of any size, from smaller deployments to large-scale networks covering extensive geographic areas, and designed to accommodate multiple bands and carriers, allowing users to scale their networks and adapt to changing technology requirements.

It is an object of the present disclosure to provide a system and a method that provide users with an updated network view and comprehensive insights into site distribution and coverage, the system improves the efficiency of network operations.

### SUMMARY

The present disclosure discloses a method of generating a real-time view in terms of a site layer view and coverage layer view for a network. The method includes storing by at least one source (160), a plurality of information corresponding to sites and coverage associated with the network. The method also includes receiving, through a user interface, a view selection for generating the site layer view and the coverage layer view. In addition, the method includes receiving, through a user interface, a site status input. The method further includes response to receiving, providing through the user interface, a technology selection option, wherein the technology selection option comprises a 4^{th} generation (4G) mobile network, a 5^{th} generation (5G) mobile network, a sixth generation (6G) mobile network, and wireless fidelity (Wi-Fi). The method also includes receiving, through the user interface, a technology selection input from the technology selection option. The method further includes generating, through the user interface, at least one output in a form of a map visualization based on the plurality of information, the view selection, the site status input, and the technology selection input.

In an embodiment, the method further includes providing, through the user interface, a site type option in response to receiving the technology selection input, for displaying a site type, wherein the site type is one of a macro cell site and a small cell site.

In an embodiment, for the site layer view, the method further includes obtaining information on site location and orientation of cells and generating the site layer view comprising the cells in a map, wherein the method comprising highlighting faulty sites in the map.

In an embodiment, the site status is at least one of indicative of sites taking traffic, indicative of sites not taking traffic, indicative of sites under construction, and indicative of sites under construction. For the coverage layer view, the method further includes obtaining coverage information offered by the sites at each of site status; and generating the site layer view comprising the cells in the map, wherein faulty sites are highlighted in the map.

In an embodiment, the method further includes providing at least one Key Performance Indicators (KPIs) in the map. The KPIs include Reference Signal Received Power (RSRP), Signal-to-Interference-plus-Noise Ratio (SINR), and throughput.

In an embodiment, the method includes receiving input to generate the coverage layer views at defined schedules, and the KPIs to be generated with the coverage layer views and the site types and generating the scheduled coverage layer views along with the corresponding KPIs and the site types, at the defined schedules.

In an embodiment, the coverage layer views are automatically updated, and wherein responsive to implementation of a new site, the new site with traffic information is displayed in the coverage layer views.

The present disclosure discloses a system for generating a real-time network view of a network. The system includes at least one source configured to store a plurality of information corresponding to sites and coverage associated with the network. The system includes a processing unit configured to generate a user interface. The user interface configured to receive a view selection for generating the site layer view or the coverage layer view, receive a site status input, provide a technology selection option, wherein the technology selection option comprises a 4^{th} generation (4G) mobile network, a 5^{th} generation (5G) mobile network, a sixth generation (6G) mobile network, and wireless fidelity (Wi-Fi), receive a technology selection input from the technology selection option; and generate at least one output in a form of a map visualization based on the on the plurality of information, the view selection, the site status input, and the technology selection input.

In an embodiment, the user interface is configured to provide a site type option in response to receiving the technology selection input, for displaying a site type, wherein the site type is one of a macro cell site and a small cell site.

In an embodiment, for the site layer view, the user interface is configured to obtain information on site location and orientation of cells and generate the site layer view comprising the cells in a map and highlight faulty sites in the map.

In an embodiment, the site status is at least one of indicative of sites taking traffic, indicative of sites not taking traffic, indicative of sites under construction, and indicative of sites under construction. For the coverage layer view, the user interface is further configured to obtain coverage information offered by the sites at each of site status and generate the site layer view comprising the cells in the map, wherein faulty sites are highlighted in the map.

In an embodiment, the interface is configured to provide at least one Key Performance Indicators (KPIs) in the map, and wherein the KPIs comprising Reference Signal Received Power (RSRP), Signal-to-Interference-plus-Noise Ratio (SINR), and throughput.

In an embodiment, the user interface is further configured to receive input to generate the coverage layer views at defined schedules, and the KPIs to be generated with the coverage layer views and the site types and generate the scheduled coverage layer views along with the corresponding KPIs and the site types, at the defined schedules.

In an embodiment, the coverage layer views are automatically updated, and wherein responsive to implementation of a new site, the new site with traffic information is displayed in the coverage layer views.

The present disclosure discloses a computer program product comprising a non-transitory computer-readable medium comprising instructions that, when executed by one or more processors, cause the one or more processors to perform a method of generating a real-time view in terms of a site layer view and coverage layer view for a network. The method includes storing by at least one source (160), a plurality of information corresponding to sites and coverage associated with the network. The method also includes receiving, through a user interface, a view selection for generating the site layer view and the coverage layer view. In addition, the method includes receiving, through a user interface, a site status input. The method further includes response to receiving, providing through the user interface, a technology selection option, wherein the technology selection option comprises a 4^{th} generation (4G) mobile network, a 5^{th} generation (5G) mobile network, a sixth generation (6G) mobile network, and wireless fidelity (Wi-Fi). The method also includes receiving, through the user interface, a technology selection input from the technology selection option. The method further includes generating, through the user interface, at least one output in a form of a map visualization based on the plurality of information, the view selection, the site status input, and the technology selection input.

The present disclosure discloses a user equipment (104) communicatively coupled with a system, the coupling comprises steps of receiving a connection request, sending an acknowledgment of connection request to the system (158); and transmitting data from a network view module (212) running in the UE (104) to the system (108) , wherein the system (108) is configured for performing of generating a real-time view in terms of a site layer view and coverage layer view for a network as claimed in claim 1.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1A illustrates an exemplary network architecture in which or with which embodiments of the present disclosure may be implemented.

FIG. 1B illustrates a block diagram of a system for generating a real-time network view of a network, in accordance with an embodiment of the present disclosure. FIG. 2 illustrates an example block diagram of the system for generating the real-time network view, in accordance with an embodiment of the present disclosure.

FIG. 3 illustrates an example flow diagram for generating the real-time network view, in accordance with an embodiment of the present disclosure.

FIG. 4 illustrates an exemplary view of accessing the network view for sites, in accordance with an embodiment of the present disclosure.

FIG. 5 illustrates an exemplary view of a sublayer option in network view to switch between various types of a network and site type, in accordance with an embodiment of the present disclosure.

FIG. 6 illustrates an exemplary representation of an interface for accessing network view coverage (coverage layer view), in accordance with an embodiment of the present disclosure.

FIG. 7 illustrates an exemplary representation of a coverage layer view generating unit (simulation system), in accordance with an embodiment of the present disclosure.

FIGS. 8A-8D illustrate exemplary representations of scheduling interfaces, in accordance with an embodiment of the present disclosure.

FIG. 9 illustrates an example computer system in which or with which the embodiments of the present disclosure may be implemented.

The foregoing shall be more apparent from the following more detailed description of the disclosure.

### LIST OF REFERENCE NUMERALS

100—Network Architecture
102—User
104—Computing device
106—Network
108—System
152—Interface
154—Selection Unit
156—Coverage layer View Generating Unit
158—System Layer View Generating Unit
160—At Least One Source
162—Display Unit
164, 712—Database
204—Memory
206—A Plurality of Interfaces
208—Processing Engine
210—Database
212—Network View Module
702—Interface
704—First repository (704)
706—Second Repository
708—Scheduling Console
710—Processing Unit
910—External Storage Device
920—Bus
930—Main Memory
940—Read Only Memory
950—Mass Storage Device
960—Communication Port
970—Processor

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time. In today's world, where communication and data transmission play an important role, network performance is crucial. Mobile network users strive to provide their customers with optimal performance, seamless connectivity and high-quality services.

Traditionally, network analysis teams are required to manage various lists of network sites manually, and then to create various network view layers manually which can be plotted on a map using desktop-based tools. For creating coverage heatmaps, engineers also use desktop-based tools, which is very tedious if the heatmaps are needed for a large area. It is difficult to manage large networks using traditional methods such as tabular format and excel sheets. Therefore, creating a network view layer using the manual approach was not possible if the network view is required in real-time or for a large area.

The present disclosure discloses a system and a method that creates a real-time network view of a network using network sites and network coverage layers. By generating a digitized view in the form of a map layer (network view), the system makes it easier to manage and improves efficiency of the network. The network view can be used to check and analyze the network.

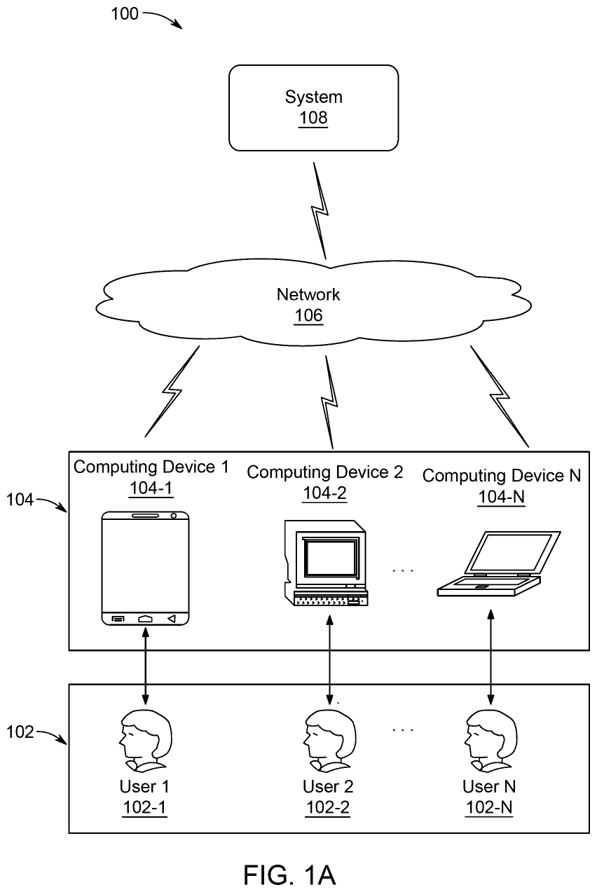

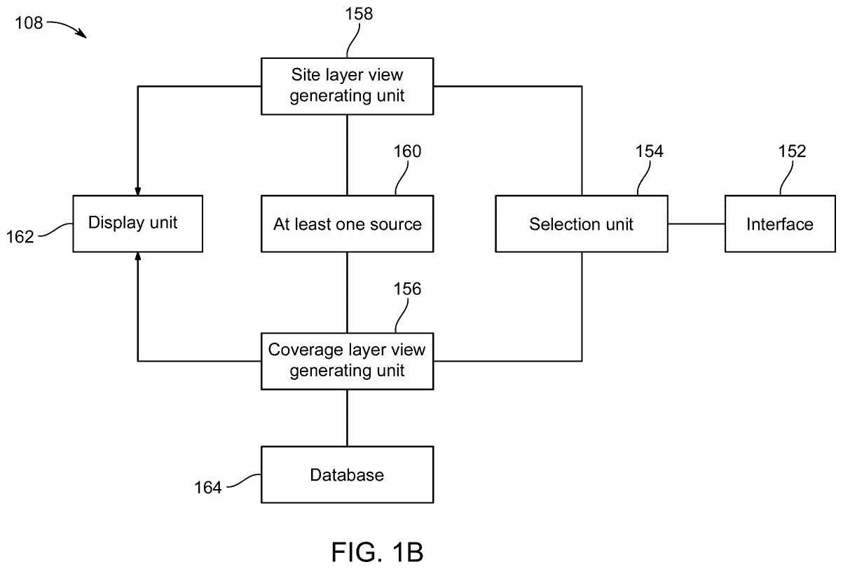

The various embodiments throughout the disclosure will be explained in more detail with reference to FIG. 1A-FIG. 9.

FIG. 1A illustrates an exemplary network architecture (100) in which or with which embodiments of the present disclosure may be implemented.

Referring to FIG. 1A, the network architecture (100) may include one or more user equipments (104-1, 104-2 . . . 104-N) associated with one or more users (102-1, 102-2 . . . 102-N) in an environment. A person of ordinary skill in the art will understand that one or more users (102-1, 102-2 . . . 102-N) may be individually referred to as the user (102) and collectively referred to as the users (102). Similarly, a person of ordinary skill in the art will understand that one or more user equipments (104-1, 104-2 . . . 104-N) may be individually referred to as the user equipment (104) and collectively referred to as the user equipment (104). A person of ordinary skill in the art will appreciate that the terms “computing device(s)” and “user equipment” may be used interchangeably throughout the disclosure. Although three user equipments (104) are depicted in FIG. 1A, however any number of the user equipments (104) may be included without departing from the scope of the ongoing description.

In an embodiment, the user equipment (104) may include smart devices operating in a smart environment, for example, an Internet of Things (IoT) system. In such an embodiment, the user equipment (104) may include, but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users (102) and/or entities, or any combination thereof. A person of ordinary skill in the art will appreciate that the user equipment (104) may include, but is not limited to, intelligent, multi-sensing, network-connected devices, that can integrate seamlessly with each other and/or with a central server or a cloud-computing system or any other device that is network-connected.

In an embodiment, the user equipment (104) may include, but is not limited to, a handheld wireless communication device (e.g., a mobile phone, a smart phone, a phablet device, and so on), a wearable computer device(e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the user equipment (104) may include, but is not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the user equipment (104) may include one or more in-built or externally coupled accessories including, but not limited to, a visual aid device such as a camera, an audio aid, a microphone, a keyboard, and input devices for receiving input from the user (102) or the entity such as touch pad, touch enabled screen, electronic pen, and the like. A person of ordinary skill in the art will appreciate that the user equipment (104) may not be restricted to the mentioned devices and various other devices may be used.

Referring to FIG. 1A, the user equipment (104) may communicate with a system (108) through a network (106). In an embodiment, the network (106) may include at least one of a Fifth Generation (5G) network, a Sixth-Generation (6G) network, or the like. The network (106) may enable the user equipment (104) to communicate with other devices in the network architecture (100) and/or with the system (108). The network (106) may include a wireless card or some other transceiver connection to facilitate this communication. In another embodiment, the network (106) may be implemented as, or include any of a variety of different communication technologies such as a wide area network (WAN), a local area network (LAN), a wireless network, a mobile network, a Virtual Private Network (VPN), the Internet, the Public Switched Telephone Network (PSTN), or the like.

As illustrated in FIG. 1A, the user equipment (104) is communicatively coupled with a system (108). The user equipment (104) may receive a connection request. The user equipment (104) may send an acknowledgment of connection request to the system (108). Data from a network monitoring application running in the user equipment (104) is sent to the system (108). The system (108) performs a coverage analysis in the network (106).

Although FIG. 1A shows exemplary components of the network architecture (100), in other embodiments, the network architecture (100) may include fewer components, different components, differently arranged components, or additional functional components than depicted in FIG. 1A. Additionally, or alternatively, one or more components of the network architecture (100) may perform functions described as being performed by one or more other components of the network architecture (100).

FIG. 1B illustrates a block diagram of a system (108) for generating a real-time network view of a network, in accordance with an embodiment of the present disclosure. In an example, the network is a 4G network, a 5G network, a 6G network, or a Wi-Fi (Wireless Fidelity) network.

As illustrated in FIG. 1B, the system (108) includes an interface (152), a selection unit (154), a coverage layer view generating unit (156), a site layer view generating unit (158), at least one source (160), a display unit (162), and a database 164.

The at least one source (160) is configured to store a plurality of information corresponding to a plurality of attributes and a plurality of characteristics associated with the network. In an example, the plurality of information includes at least one range corresponding to each attribute and each characteristics. For example, the plurality of attributes or Key Performance Indicator (KPIs) include a received signal strength indicator (RSRP), a signal-to-interference-plus noise ratio (SINR), a downlink (DL) throughput, uplink (UL) throughput, a reference signal received quality (RSRQ), a received signal strength indicator (RSSI), and a best server plot. The RSRP is a parameter used in wireless communication systems to measure the quality of a received signal. The RSRP represents the power of a reference signal received by a receiver (UE), normalized to the power of a transmitted signal. A higher RSRP indicates a stronger signal, while a lower RSRP indicates a weaker signal. RSRP is commonly used to evaluate the quality of a received signal and estimate the amount of data that can be transmitted without errors. The UE usually measures RSRP or RSRQ based on the direction (RRC message) from the network and report the value. RSSI indicates the strength of the signal received by UE. RSSI considers not only the useful signal of a cell, but also all the secondary signal in the measured frequency range. For example, the RSSI value includes the signal of neighbouring base stations, internal and external interference, and noise. SINR measures signal quality by comparing a strength of a required signal compared to the unnecessary interference and noise. Mobile network operators seek to maximize SINR at all sites to deliver the best possible customer experience, either by transmitting at a higher power, or by minimizing the interference and noise. In an example, the at least one source (160) is one of an operational support system (OSS), a unified data repository (UDR), and a plurality of network functions located in the network. In an example, the plurality of characteristics includes network site, prediction layer, measured layer, hybrid layer, analytics, topologies, locations and boundaries, and base maps.

In an embodiment, the at least one source (160) serves as a central repository for storing updated site information for all live nodes (network sites) in the network. The purpose of the at least one source (160) is to maintain accurate and current data about the network sites. The at least one source (160) is designed to automatically update whenever there are changes in the status of any sites in the network. This means that whenever a site goes on air, becoming operational and providing network services, or goes non-radiating, temporarily or permanently ceasing its operations, the at least one source (160) is updated accordingly. For example, when a site goes on air, the at least one source (160) is updated with the relevant site information, such as its location, technology, antenna configuration, coverage area, and any other pertinent details. Similarly, if a site goes non-radiating, the at least one source (160) reflects this change by updating the site's status and making it inactive or non-operational in the network view.

The interface (152) provides an option for a user to select a type of the network view. For example, the type of the network view includes a network site layer view (also referred to as a site layer view) or a coverage layer view. In an embodiment, the interface (152) is a touch screen or a pointer device. In an example, the interface (152) is a Web Browser (e.g., INTERNET EXPLORER manufactured by Microsoft Corp. of Redmond, Wash. or SAFARI, manufactured by Apple Computer of Cupertino, Calif.). The interface (152) is further configured to receive, from the user, at least one user-defined information. The user can define certain information (user-defined information) when generating a coverage layer view. In an example, the one user-defined information includes at least one scheduling time for generating the coverage layer map, a defined number of generating the coverage layer map, the at least one attribute, and a list of coverage layer views to be generated.

The selection unit (154) is commutatively coupled with the interface (152). The selection unit (154) is configured to receive a selection of at least one attribute from the plurality of attributes and at least one characteristic from the plurality of characteristics from the user. In an example, the plurality of characteristics includes a network site, and a prediction layer. In an example, the selection unit (154) is configured to display the plurality of attributes on the interface (152) such that the user is able to select the at least one attribute. In an example, the user is able to select the attribute(s) according to which the system (108) is able to generate the coverage layer view. In another example, the selection unit (154) is configured to display the plurality of characteristics on the interface (152) such that the user is able to select the at least one characteristic. In an example, the user is able to select the characteristic(s) from the plurality of characteristics according to which the system (108) is able to generate the network site layer view. In an example, the selection unit (154) is configured to store the selected attributes and characteristics in the database 164.

The site layer view generating unit (158) is configured to cooperate with the at least one source (160) and the selection unit (154). The site layer generating unit (158) receives the stored plurality of information from the at least one source (160) corresponding to the at least one characteristic selected by the user. Further, the site layer generating unit (158) is configured to process the received information to generate the network site layer view as per the selected characteristic. In an aspect, the site layer view includes at least one icon corresponding to each of the plurality of characteristics. Further, at least one icon further includes at least one sub-layer option enabling the user to switch between a 4G network layer data, a 5G network layer data or a 6G network layer data.

The coverage layer view generating unit (156) is configured to cooperate with the at least one source (160) and the selection unit (154). The coverage layer view generating unit (156) extracts the stored plurality of information from the at least one source (160) corresponding to the at least one attribute selected by the user. The coverage layer view generating unit (156) is configured to process the extracted information to generate the at least one coverage layer view in a form of a map visualization as per the selected attribute. The site layer view generating unit 158 and the coverage layer view generating unit 156 are shown in a combined form as a network view generating unit (200) in FIG. 2.

The display unit (162) is configured to cooperate with the coverage layer view generating unit (156) and the site layer view generating unit (158). The display unit (162) is configured to further configured to display the generated real-time network view and the generated network site layer view. Although the display unit (162) is shown as a unit, the display unit (162) may be part of UE (104).

The database 164 is configured to storing the at least one generated coverage layer view as a map data tile or as an image. The database 164 is configured to store the input (selected attributes, selected characteristics, selected type of the network view) received from the user. The database 164 is configured to store at least one generated coverage layer view as a map data tile or as an image, such that the system is configured to analyze the stored coverage layer view for generating at least one pattern, at least one trend, and at least one anomaly related to the network. The database 164 is configured to store the generated network views corresponding to the number of selections. The database 164 is configured to store computer-readable instructions. The database 164 may include any computer-readable medium known in the art including, for example, volatile memory, such as static random access memory (SRAM) and dynamic random access memory (DRAM) and/or non-volatile memory, such as read only memory (ROM), erasable programmable ROM, flash memories, hard disks, optical disks, and magnetic tapes. The database 164 may comprise, for example, a conventional relational database management system (RDBMS), such as one available from ORACLE®, SYBASE®, or the like.

In an example, the network layer view includes at least one icon corresponding to each of the plurality of characteristics. In an example, the at least one icon includes a network site icon, a prediction layer icon, a measured layer icon, a hybrid layer icon, an analytics icon, a topologies icon, a locations and boundaries icon, and a base maps icon. In an embodiment, the at least one icon further includes at least one sub-layer option.

In an embodiment, the system (108) is configured to employ automatically updating to update network layer view when a network site enters or exits the network.

In an embodiment, the network may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an operative aspect, the system (108) is configured to implements a map visualization view of sites which gets updated on real-time, and also implements a coverage layer that is dynamically updated in real-time if a new site gets on air, reflecting changes in the network. The system (108) provides visual representation of the map visualization that automatically updates when new site becomes operational. By automatically updating the network view, the system (108) eliminates the need for manual data collection and maintenance for the site layer and heatmap creation using simulation engines.

The map visualization of sites is continuously updated in real-time, reflecting the changes occurring in the network. This means that as new sites are deployed or existing sites are modified, the map layer view (network site layer view) is automatically adjusted to incorporate these changes. This provides users with an accurate and current visual representation of the network's sites. Additionally, the system (108) implements the coverage layer view that is also dynamically updated in real-time. Specifically, when a new site becomes operational, the coverage layer view is automatically adjusted to reflect the coverage and performance of the newly added site. This allows users to visualize and analyze the impact of the new site on the network's coverage and performance metrics.

By implementing these real-time updates for both the site layer view of sites and the coverage layer view, the system (108) eliminates the need for manual data collection and maintenance. In traditional approaches, collecting and managing data for the site layer and generating maps would require significant manual effort. However, in this system (108), the updates are performed automatically, eliminating the need for manual intervention.

Furthermore, the system (108) leverages simulation engines to generate the coverage layer view and heat maps, which consider various factors such as technology, bands, and network parameters. The automated updates ensure that the network view remains accurate and up to date, providing users with an efficient and reliable means of visualizing and analyzing the network.

FIG. 2 illustrates an example network view generating unit (200), in accordance with an embodiment of the present disclosure.

Referring to FIG. 2, in an embodiment, the network view generating unit (200) may include a memory (204) configured to store computer-readable instructions. The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the network view generating unit (200) may include an interface(s) (206). The interface(s) (206) may comprise a variety of interfaces, for example, interfaces for data input and output devices (I/O), storage devices, and the like. The interface(s) (206) may facilitate communication through the network view generating unit (200). The interface(s) (206) may also provide a communication pathway for one or more components of the network view generating unit (200). In examples, the interface (206) is same as the interface (152). Examples of such components include, but are not limited to, processing engine(s) (208) and a database (210). Further, the processing engine(s) (208) may include a network view engine (212) and other engine(s). In an embodiment, the other engine(s) may include, but not limited to, a data ingestion engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the network view generating unit (200) may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

In an embodiment, the processing engine(s) (208) may be configured to utilize the network view module (212) to automate the process of updating the site layer and heatmap layer using simulation engines. This automation eliminates the requirement for manual data collection and maintenance, as the system (108) takes care of updating the network view automatically. Furthermore, the system (108) includes a map layer view of sites that is dynamically updated in real-time, ensuring that any changes in the network, such as new site deployments or modifications, are immediately reflected in the network view. This real-time update capability enhances the accuracy and relevance of the network view.

Additionally, the processing engine(s) (208) incorporates a heatmap layer that automatically updates when a new site becomes operational. This means that as soon as a new site is deployed and becomes active, the heatmap layer is automatically adjusted to include the coverage and performance data of the new site. This ensures that the heatmap accurately represents the network's current state and provides up-to-date information for analysis and decision-making.

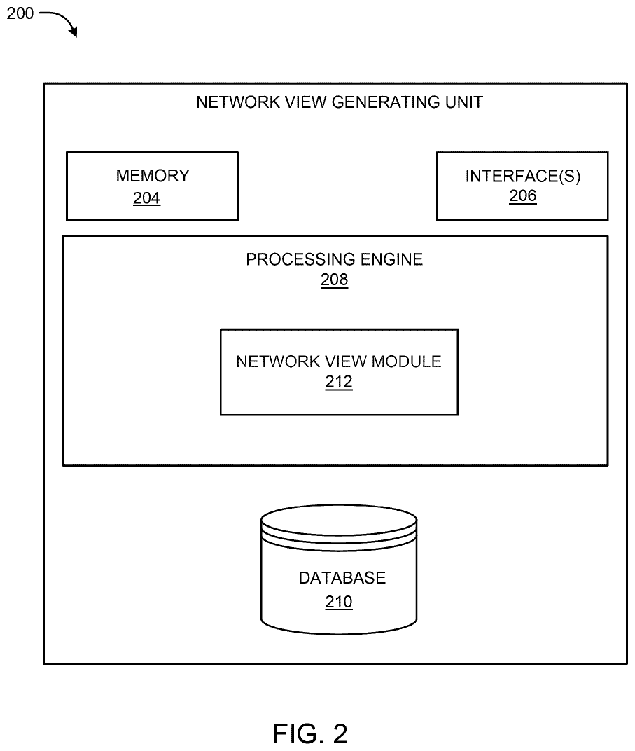

FIG. 3 illustrates an example flow diagram for generating the real-time network view, in accordance with an embodiment of the present disclosure.

At step 302, the system (108) stores the plurality of information corresponding sites and coverage. The plurality of information includes the plurality of attributes and the plurality of characteristics associated with the network in at least one source (160). For example, the plurality of attributes or key performance indicators (KPIs) include a received signal strength indicator (RSRP), a signal-to-interference ratio (SINR), a downlink (DL) throughput, uplink (UL) throughput, a reference signal received quality (RSRQ), a received signal strength indicator (RSSI), and a best server plot. In an example, the plurality of characteristics includes network site, prediction layer, measured layer, hybrid layer, analytics, topologies, locations and boundaries, and base maps.

At step 304, the system (108) receiving, through a user interface, a view selection for generating the site layer view or the coverage layer view. In an example the network site layer view illustrates various characteristics associated with the network such distribution of network sites. In another example, the coverage layer view illustrates various attributes associated with the network such as coverage area of 4G, 5G, 6G, and Wi-Fi associated network sites.

At step 306, the system (108) receives, via the selection unit (154) through the user interface, a site status input. The site status includes at least one of indicative of sites taking traffic, indicative of sites not taking traffic, indicative of sites under construction, and indicative of sites planned for futuristic coverage.

At step 308, the system (108) in response to receiving, providing through the user interface, a technology selection option. The technology selection option comprises a 4^{th} generation (4G) mobile network, a 5^{th} generation (5G) mobile network, a sixth generation (6G) mobile network, and wireless fidelity (Wi-Fi).

At step 310, the system (108) receives, through the user interface, a technology selection input of the user from the technology selection option.

At step 312, the system (108) generates, through the user interface, at least one output in a form of a map visualization based on the plurality of information, the view selection, the site status input, and the technology selection input. In examples, the processing engine (208), processes the plurality of information based on the view selection, the site status input, and the technology selection input to generate the map visualization.

The flow also includes providing a site type option in response to receiving the technology selection input, for displaying a site type. The site type may be a macro cell site, a small cell site, a pico site, etc.

For generating the network site layer view, the system obtains coverage information offered by the sites at each of site status and generates the site layer view comprising the cells in the map. In examples, faulty sites are highlighted in the site layer view shown in the map.

For generating the network site layer view, the system obtains coverage information offered by the sites at each of site status and generates the site layer view comprising the cells in the map. In examples, the faulty sites are highlighted in the coverage layer view.

In examples, the system provides options to generate coverage layer views at defined schedules. The defined schedules may be defined by the user. For example, the defined schedules may include one time, daily, weekly, monthly, or custom intervals. To generate coverage layer views at defined schedules, the system (108) receives schedule input from to generate the coverage layer views, and the KPIs to be generated with the coverage layer views and the site types. Based on the user schedule input, the system generates the scheduled coverage layer views along with the corresponding KPIs and the site types, at the defined schedules.

In examples, the network layer views and the coverage layer views are automatically updated. In instances, where a new site is implemented or old site is removed, the new site with traffic information is displayed in the coverage layer views or the old remove site is shown, respectively.

During the step of generating the at least one coverage layer view, the scheduling console generates the triggering event based upon the at least one user-defined information fetched from the first repository (704). In an aspect, the scheduling console may be configured to generate an activation sequence of the generated triggering event(s) based on the received defined information. The second repository is configured to store the generated activation sequence. The scheduling console generates a request for executing the generated triggering event(s) based on the activation sequence. The processing engine (208) is configured to retrieve the attribute corresponding to the triggering event on receiving the request from the scheduling console to generate the at least one coverage layer view accordingly.

In an embodiment, the method further includes a step of displaying the generated real-time network view on the display unit (162). In an example, the display unit (162) is a liquid crystal display, a plasma display panel (PDP), or a light emitting display.

In examples, the method flow (300) as described is part of a computer program product comprising a non-transitory computer-readable medium comprising instructions that, when executed by one or more processors, cause the one or more processors to perform the method (300) of generating a real-time view in terms of a site layer view and coverage layer view for a network.

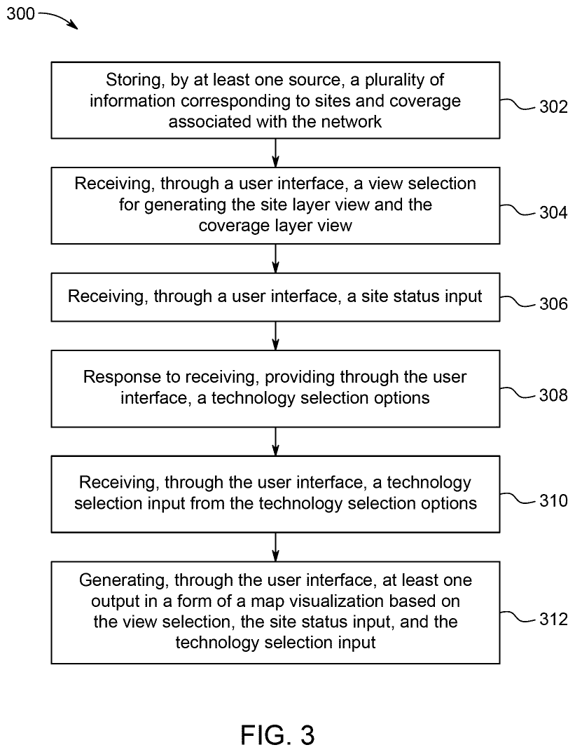

FIG. 4 illustrates an exemplary view 400 of accessing the network layer view for network sites, in accordance with an embodiment of the present disclosure. As shown in FIG. 4, the site icon includes various sub-layer options. For example, the site icon includes two sub-layer options such as an outdoor site and an indoor site. In an example, each sub-layer option may include various site status options (such as approved nominal (indicative of sites planned for futuristic coverage), planned (indicative of sites under construction), on air (indicative of sites taking traffic), off air (indicative of sites not taking traffic)). In an example, by selecting the on-air option, the user is able to generate the network layer view having active network sites only. The interface is able to provide various user interface (UI) options to access the network view for outdoor sites (as shown by 402). Furthermore, the interface is able to provide various user interface (UI) options to access the network view for indoor sites (as shown by 404). The UI network view is designed on a web portal of the system (108) (or a specified platform) to provide users with a convenient and intuitive way to access and interact with the network view. As shown in FIG. 4, users have option to choose between viewing outdoor and indoor sites, and this selection allows users to focus on specific types of sites based on their requirements or analysis needs.

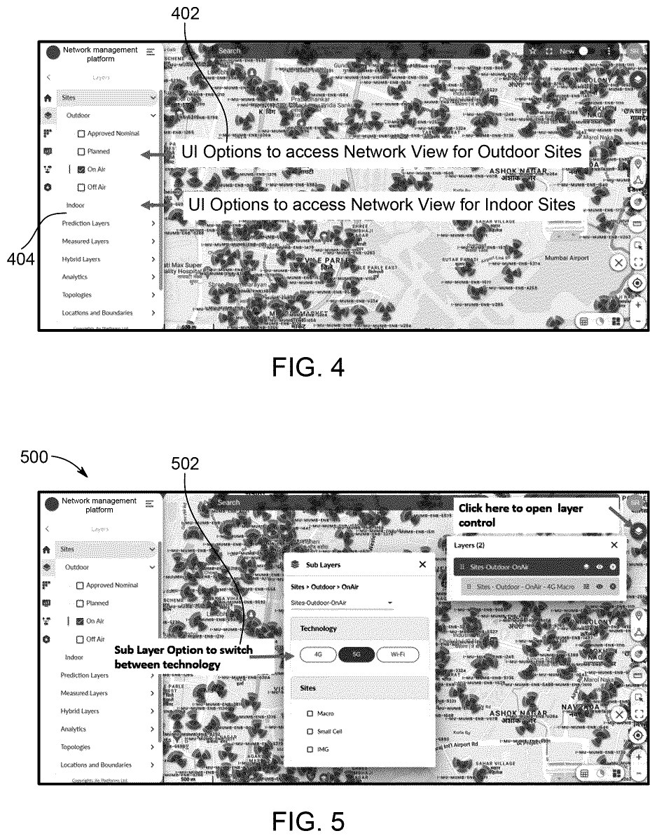

FIG. 5 illustrates an exemplary view 500 of the sublayer technology selection option in network view to switch between various types of a network and site type, in accordance with an embodiment of the present disclosure. Further, to select technology user may select a “Sublayer” menu option, as shown in FIG. 5. This menu option allows users to select the technology they want to view in the network, for example, between 4G, 5G and Wi-Fi. By using the sublayer option, users can easily switch between the two network technologies and observe the site distribution and coverage specific to each technology. By selecting the desired technology option sublayer (4G, 5G or Wi-Fi), users can customize their network view to display only the relevant information based on the technology they are interested in analyzing or monitoring. This user interface design provides flexibility and convenience for users to explore and compare the network view from different technology perspectives. It empowers users to visualize the distribution of outdoor and indoor sites, as well as the coverage and performance metrics specific to each technology layer (4G or 5G), enhancing their ability to analyze and optimize the network effectively. As shown in FIG. 5, the sub-layer option 502 is configured to provide a number of technology selection options to select a desired network type. As shown in FIG. 5, the user is able to select a 4G network, a 5G network, or a wi-fi network.

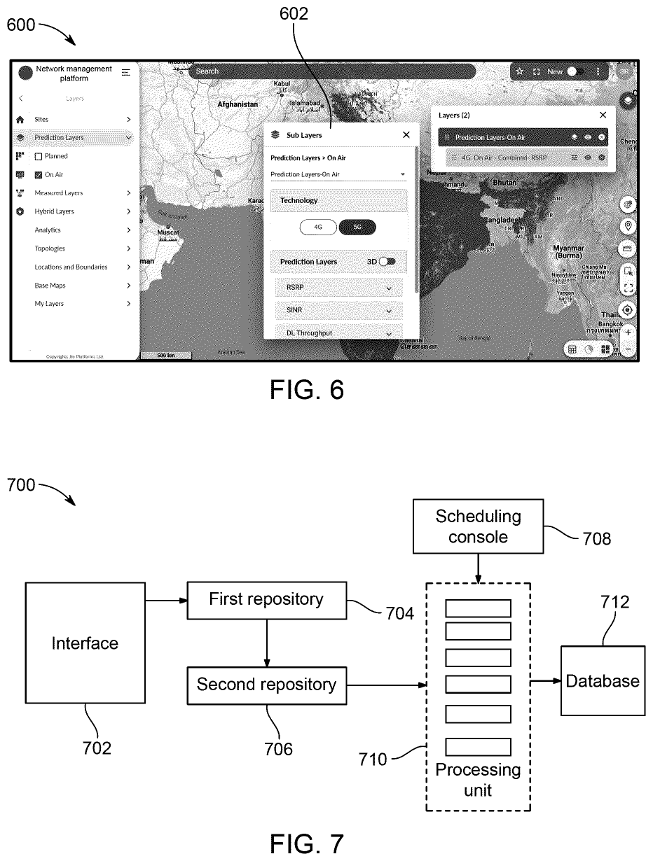

FIG. 6 illustrates an exemplary representation of an interface for accessing network view coverage (coverage layer view), in accordance with an embodiment of the present disclosure. In an example, to generate the coverage layer view, there is an icon (“Prediction Layer”) that allows users to check the network coverage, and accessible to users by clicking on sublayer menu option, as shown in FIG. 6 of the user interface. When the user clicks on the “Prediction Layer”, it provides them with a visual representation (coverage layer view) of the network coverage. This layer incorporates predictive modelling or simulation algorithms to estimate the expected coverage areas based on various factors such as signal strength, antenna configurations, terrain data, and other relevant parameters. Furthermore, the user has the flexibility to switch between the technologies such as 4G and 5G networks within the prediction layer. This switching capability is enabled through the sublayer menu option, as referenced in FIG. 5 of the user interface. Moreover, by utilizing the sublayer menu option, users can choose to view the network coverage specifically for either the 4G or 5G technology. This allows users to analyze and compare the coverage areas and performance metrics of the different network technologies, aiding in network planning, optimization, and decision-making.

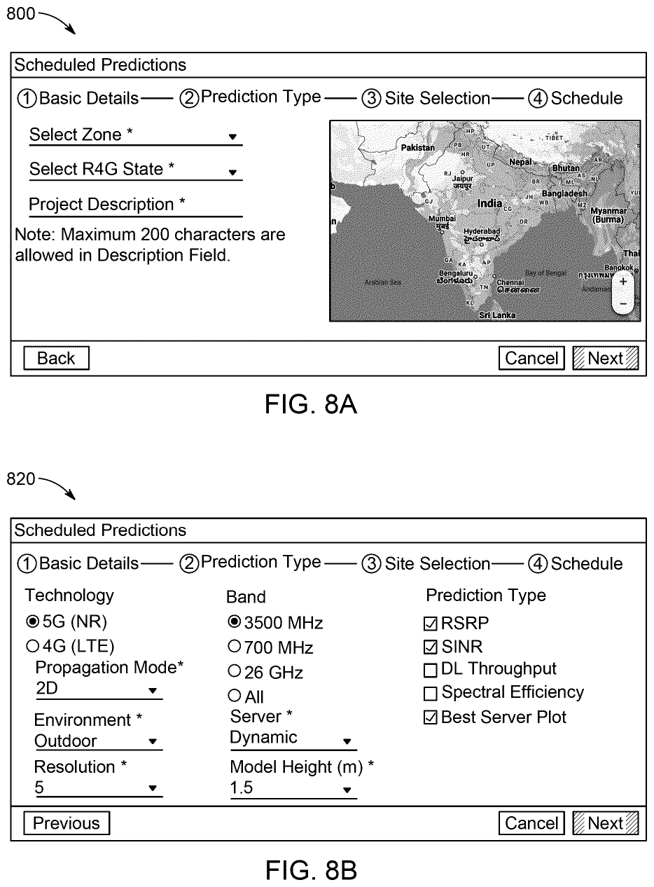

FIG. 7 illustrates an exemplary representation of the coverage layer generating unit (simulation system) 700, in accordance with an embodiment of the present disclosure. In an embodiment, the system (108) includes the simulation system for generating the network heat maps (interchangeably referred to as coverage layer view) using components as shown in FIG. 7. The coverage layer generating unit 700 includes an interface 702, a first repository (704) 704, a second repository 706, a scheduling console 708, a processing unit 710 and a database 712.

The interface 702 is further configured to receive, from the user, at least one user-defined information. In an example, the one user-defined information includes at least one scheduling time for generating the coverage layer view, a defined number of generating the coverage layer view, the at least one attribute, and a list of coverage layer views to be generated.

The first repository (704) is configured to cooperate with the interface (152) to receive the at least one user-defined information and stores the received user-defined information. In an embodiment, the first repository (704) (for example a ScheduledJobDetail table) is configured to save details, when user specifies the coverage layer and/or heat map generation requirements. The first repository (704) serves as an intermediate storage for the information provided by the user during the configuration of coverage layer view and/or heat map generation. By storing the coverage layer generation requirements in the first repository (704), the system (108) ensures that the information is captured and preserved for further processing. This allows for subsequent steps in the coverage layer generation process to retrieve the necessary details and initiate the generation process based on the user's specifications.

The scheduling console (708) is configured to cooperate with the first repository (704) to receive the stored information. The scheduling console (admin console) (708) is configured to receive at least one scheduling time and the at least one attribute from the user for generating the at least one coverage layer view at the scheduling time. The scheduling console (708) is further configured to generate a triggering event based upon the received information. The admin console enables administrators to schedule predictions and configure the frequency of coverage layer view generation. The admin console provides a convenient platform for administrators to input their preferences and settings regarding the generation of coverage layer view in form of maps. The administrators can access the admin console to specify various parameters for generating the coverage layer view and/or heat maps. These inputs are collected through the interface and then saved to the first repository (704). The first repository (704) is configured to store the generated triggering event(s) along with the at least one scheduling time and the received attribute. In an aspect, the scheduling console (708) is further configured to generate an activation sequence of the generated triggering event(s) based on the received at least one information. The admin can input the desired frequency for the generation of coverage layer view and/or heat maps. The inputs provided by the admin, such as the date and time of the coverage layer view and/or heat map generation, are collected and stored in the “Scheduledjobdetails” table for future reference. The table contains all the details of the scheduled job, such as the admin's name, the frequency of the job, and the date and time of the last run. This information can be used by the admin to monitor and manage the scheduled jobs. Overall, the schedule console simplifies the process of setting up and managing the generation of coverage layer view and/or heat maps.

The second repository (706) is configured to store the activation sequence of the generated triggering event(s) based on the at least one scheduling time. The scheduling console (708) is configured to cooperate with the second repository and is configured to generate request for executing the triggering event based on the activation sequence. In an embodiment, the second repository (706) is configured to queued up whenever any job is to be triggered (it is scheduling time comes). The scheduler (the scheduling console (708)) sends request to the processing unit (710) for generating the coverage layer view. The processing unit (710) generates the coverage layer view as coverage layer view and/or heat maps on basis the inputs configured by admin through scheduling console. The processing unit (710) is configured to receive the request from the scheduling console (708) and is configured to retrieve the received attribute from the first repository (704) corresponding to the triggering event. Based on the retrieved attribute, the processing unit (710) generates the at least one coverage layer view accordingly.

In an embodiment, when the coverage layer view and/or heat maps are generated by the coverage layer view generating unit (700), they are saved as image files. The system (108) then stores these image files in the database 712, associating them with the corresponding sites or locations within the network. By storing the coverage layer view and/or heat maps in image file format within the database 712, the system (108) ensures that the generated maps can be easily accessed and retrieved when needed. This format allows for efficient storage, retrieval, and sharing of the coverage layer view and/or heat maps, as images can be readily displayed and analyzed by users.

The database 712 serves as a centralized location for storing the coverage layer view and/or the heat maps, providing a structured and organized repository for managing and accessing the generated data. It enables users to retrieve and view the coverage layer view and/or the heat maps based on specific criteria, such as site location, technology, or time period.

The processing unit (710) is configured to receive the activation signal from the scheduling console (708) and is configured to retrieve the received attribute corresponding to the triggering event from the at least one source (160) or the first repository (704) for generating the at least one coverage layer view and/or the heat map accordingly.

In an embodiment, the at least one source (160) is configured to automatically update whenever there are changes in the status of any sites in the network. Whenever a network site goes on air, becoming operational and providing network services, or goes non-radiating, temporarily or permanently ceasing its operations, the at least one source (160) is updated accordingly. For example, when a network site goes on air, the at least one source (160) is updated with the relevant site information, such as its location, technology, antenna configuration, coverage area, and any other pertinent details. Similarly, if a site goes non-radiating, the at least one source (160) reflects this change by updating the site's status and making it inactive or non-operational in the network view.

The automated updating process ensures that the at least one source (160) always contains the most up-to-date information about the live nodes in the network. By automatically capturing these site status changes, the system (108) maintains the accuracy and integrity of the database without relying on manual updates or interventions. Moreover, the at least one source (160) is crucial for various network management tasks, such as monitoring the network's overall health, analyzing site performance, optimizing coverage and capacity, and making informed decisions regarding network planning and expansion.

In an embodiment, the database 712 stores the coverage layer views. These coverage layer views represent the network coverage and are stored in the form of map tiles or images. The purpose of the database 712 is to provide a convenient and efficient way to store and access the coverage layer views for analysis and visualization. The coverage layer views are stored at different enlargement levels, ranging from, for example, zoom level 4 to zoom level 18. Zoom levels/enlargement levels refer to the level of magnification or detail at which the maps are displayed. Lower zoom levels show a broader view of the coverage, while higher zoom levels provide a more detailed and localized view. Moreover, by storing the coverage layer views in the form of map tiles or images, the system (108) can retrieve and display the appropriate coverage layer view tiles based on the user's desired zoom level and geographic area of interest. This enables users to explore the coverage layer views at different levels of granularity and focus on specific regions or areas within the network.

The use of the database 712 for storing the coverage layer views allows for efficient data retrieval and management. The system (108) ensures that the coverage layer view and/or are readily accessible and can be retrieved and displayed in a timely manner when needed for analysis or visualization purposes.

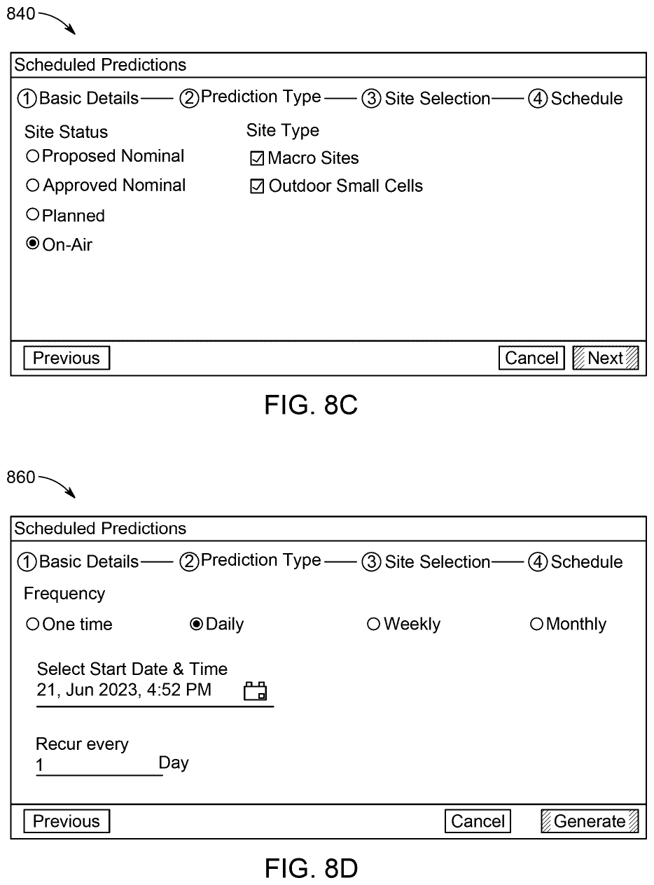

FIGS. 8A-8D illustrate exemplary representations of scheduling interfaces, in accordance with an embodiment of the present disclosure.

FIG. 8A showcases an exemplary representation 800 of scheduling interface having an option in the admin console that allows the administrator (user) to provide basic details such as selecting a target area for which the coverage layer view on a map is needed. This selection enables the system (108) to focus on generating maps having the coverage layer view specifically for the designated geographic region. As shown in FIG. 8A, the user (admin) is able to select basic details such as zone, state, or a project name.

FIG. 8B demonstrates another exemplary representation 820 of another option available in the admin console, which enables the administrator to select the technology, band, and prediction of coverage layer view type. This selection helps determine the specific parameters and metrics to be considered in generating the map having the coverage layer view. As shown in FIG. 8B, the user is able to select details such as technology options, propagation mode, environment, resolution, band, and predication type (attributes).

FIG. 8C showcases another exemplary representation 840 of another option where the administrator can choose the specific sites for which map having the coverage layer views are required. This allows administrators to generate map having the coverage layer view selectively for particular sites of interest within the network. As shown in FIG. 8C, the user is able to select basic details such as the site types and the site status.

FIG. 8D illustrates an option 860 within the admin console that allows the administrator to select defined schedules that includes a periodicity or frequency at which the coverage layer view should be generated. This could include options such as one time, daily, weekly, monthly, or custom intervals based on the administrator's preferences. As shown in FIG. 8D, the user is able to select a specific time and date to generate the coverage layer view and/or.

In an exemplary embodiment, the present disclosure discloses a user equipment which is configured to generate a real-time network view of a network. The user equipment includes a processor, and a computer readable storage medium storing programming instructions for execution by the processor. Under the programming instructions, the processor is configured to store a plurality of information corresponding to a plurality of attributes and a plurality of characteristics associated with the network in the computer readable storage medium. Under the programming instructions, the processor is configured to prompt, by an interface, a user to select a type of the network view, wherein the type includes a network site layer view or a coverage layer view. Under the programming instructions, the processor is configured to receive, by a selection unit, a selection of at least one attribute from the plurality of attributes from the user for generating the coverage layer view or at least one characteristic from the plurality of characteristics for generating the network site layer view. Under the programming instructions, the processor is configured to receive, by a network view generating unit, the stored plurality of information from the at least one source corresponding to the at least one characteristic associated with the network and processes the received information to generate the network site layer view. Under the programming instructions, the processor is configured to extract, by a coverage layer view unit, the plurality of information from the at least one source corresponding to the at least one attribute associated with the network and processes the extracted information to generate the at least one coverage layer view view.

Moreover, by utilizing the admin console and its various options, administrators can effectively configure and schedule the generation of coverage layer view according to their specific requirements and operational needs.

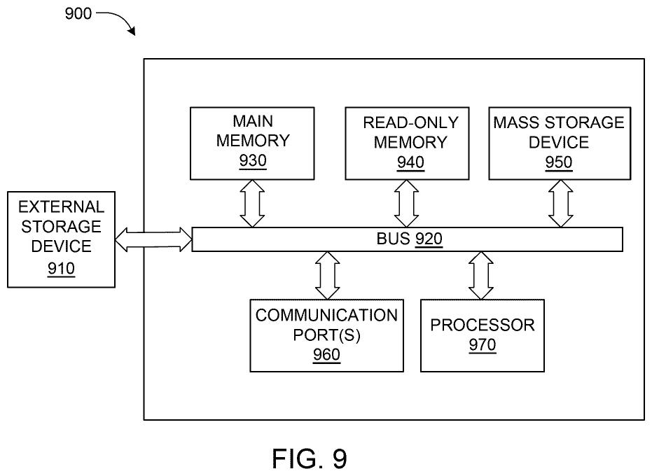

FIG. 9 illustrates an example computer system (900) in which or with which the embodiments of the present disclosure may be implemented.

As shown in FIG. 9, the computer system (900) may include an external storage device (910), a bus (920), a main memory (930), a read-only memory (940), a mass storage device (950), a communication port(s) (960), and a processor (970). A person skilled in the art will appreciate that the computer system (900) may include more than one processor and communication ports. The processor (970) may include various modules associated with embodiments of the present disclosure. The communication port(s) (960) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (960) may be chosen depending on a network, such as a Local Area Network (LAN), Wide Area Network (WAN), or any network to which the computer system connects.

In an embodiment, the main memory (930) may be Random Access Memory (RAM), or any other dynamic storage device commonly known in the art. The read-only memory (940) may be any static storage device(s) e.g., but not limited to, a Programmable Read Only Memory (PROM) chip for storing static information e.g., start-up or basic input/output system (BIOS) instructions for the processor (970). The mass storage device (950) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (920) may communicatively couple the processor(s) (970) with the other memory, storage, and communication blocks. The bus (920) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (970) to the computer system (900).

In another embodiment, operator and administrative interfaces, e.g., a display, keyboard, and cursor control device may also be coupled to the bus (920) to support direct operator interaction with the computer system (900). Other operator and administrative interfaces can be provided through network connections connected through the communication port(s) (960). Components described above are meant only to exemplify various possibilities. In no way should the aforementioned exemplary computer system (900) limit the scope of the present disclosure.

Therefore, the present disclosure is configured to provide an enhanced interactive system which is configured to create dynamic network view in real-time based on user interaction. Using the present system, the user is able to customize the network view to highlight specific data points (coverage, network site, network type), and incorporate a scheduler for generating network views on a specific time. Develop an interactive map with real-time layers, showing the location of cellular sites and their coverage areas. The system implements color-coded heatmaps to represent live signal strength, network congestion, and areas with high user activities. The present disclosure is applicable to a wide range of applications that require real-time performance tracking of the network cell in real time. With the fast advances of 5G standardization, the present disclosure may be applicable to performance-based services-related use cases. By applying real-time network analysis using the system, network operators can proactively manage and optimize their infrastructure to meet the increased demand during events, ensuring a seamless and reliable mobile experience for attendees.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions, or examples, which are included to enable a person having ordinary skill in the art to make and use the present disclosure when combined with information and knowledge available to the person having ordinary skill in the art.

### ADVANTAGES OF THE INVENTION

The present disclosure provides a system and a method that eliminates need for manual data collection and maintenance by automating the process of creating and updating the network view and provides real-time updates to the site layer and heatmap layer, ensuring that the network view reflects the current state of the network accurately.

The present disclosure provides a system and a method that significantly reduces the effort required to collect and maintain data for the site layer and heatmap layer, and operators can focus their resources on other critical tasks instead of spending time on manual data management.

The present disclosure provides a system and a method that implements a map layer view of sites and coverage, presenting the network view in an intuitive and visual manner, and this digitized representation on a map interface simplifies the understanding of the network layout, site distribution, and coverage areas.

The present disclosure provides a system and a method that enables efficient network analysis by providing a user-friendly web interface for viewing the network, and the operator easily analyzes the network's performance, identifies coverage gaps, and makes informed decisions for network optimization.

The present disclosure provides a system and a method that facilitates geospatial analysis by providing a comprehensive view of live sites in the network and their coverage. Operators can perform spatial analysis, and assess network performance in

The present disclosure provides a system and a method that is applicable to various generations of mobile technology, including 2G, 3G, 4G, 5G, and beyond. It also supports networks with multiple technology vendors, allowing operators to manage diverse network infrastructures efficiently.

The present disclosure provides a system and a method that handles networks of any size, from smaller deployments to large-scale networks covering extensive geographic areas, and designed to accommodate multiple bands and carriers, allowing operators to scale their networks and adapt to changing technology requirements.

The present disclosure provides a system and a method that provide users with an updated network view and comprehensive insights into site distribution and coverage, the system improves the efficiency of network operations.

We claim:

1. A method (300) of generating a real-time view in terms of a site layer view and coverage layer view for a network, the method comprising:
storing by at least one source (160), a plurality of information corresponding to sites and coverage associated with the network;
receiving, through a user interface (152, 206), a view selection for generating the site layer view or the coverage layer view;
receiving, through the user interface (152, 206), a site status input;
response to the receiving, providing through the user interface (152, 206), a technology selection option, wherein the technology selection option comprises a 4^{th} generation (4G) mobile network, a 5^{th} generation (5G) mobile network, a sixth generation (6G) mobile network, and wireless fidelity (Wi-Fi);
receiving, through the user interface (152, 206), a technology selection input from the technology selection option; and
generating, through the user interface (152, 206), at least one output in a form of a map visualization based on the plurality of information, the view selection, the site status input, and the technology selection input.

2. The method of claim 1, further comprising providing, through the user interface, a site type option in response to receiving the technology selection input, for displaying a site type, wherein the site type is one of a macro cell site and a small cell site.

3. The method of claim 1, wherein for the site layer view, the method further comprising:
obtaining information on site location and orientation of cells; and
generating the site layer view comprising the cells in a map, wherein the method comprising highlighting faulty sites in the site layer view.

4. The method of claim 1, wherein the site status is at least one of indicative of sites taking traffic, indicative of sites not taking traffic, indicative of sites under construction, and indicative of sites planned for futuristic coverage, wherein for the coverage layer view, the method further comprising:
obtaining coverage information offered by the sites at each of site status; and
generating the site layer view comprising the cells in the map, wherein faulty sites are highlighted in the coverage layer view provided in the map.

5. The method of claim 4, further comprising providing at least one Key Performance Indicators (KPIs) in the map, and wherein the KPIs comprising Reference Signal Received Power (RSRP), Signal-to-Interference-plus-Noise Ratio (SINR), and throughput.

6. The method of claim 5, further comprising:
receiving input to generate the coverage layer views at defined schedules, and the KPIs to be generated with the coverage layer views and the site types; and
generating the scheduled coverage layer views along with the corresponding KPIs and the site types, at the defined schedules.

7. The method of claim 6, wherein the coverage layer views are automatically updated, and wherein responsive to implementation of a new site, the new site with traffic information is displayed in the coverage layer views.

8. A system (108) for generating a real-time network view of a network, said system (108) comprising:
at least one source (160) configured to store a plurality of information corresponding to corresponding to sites and coverage associated with the network; and
a processing engine (208) configured to generate a user interface (152, 206), the user interface (152, 206) configured to:
receive a view selection for generating the site layer view or the coverage layer view;
receive a site status input;
provide a technology selection option, wherein the technology selection option comprises a 4^{th} generation (4G) mobile network, a 5^{th} generation (5G) mobile network, a sixth generation (6G) mobile network, and wireless fidelity (Wi-Fi);
receive a technology selection input from the technology selection option; and
generate at least one output in a form of a map visualization based on the on the plurality of information, the view selection, the site status input, and the technology selection input.

9. The system of claim 8, wherein the user interface (206) is configured to provide a site type option in response to receiving the technology selection input, for displaying a site type, wherein the site type is one of a macro cell site and a small cell site.

10. The system of claim 8, wherein for the site layer view, the user interface (206) is configured to:
obtain information on site location and orientation of cells; and
generate the site layer view comprising the cells in a map and highlight faulty sites in the map.

11. The system of claim 8, wherein the site status is at least one of indicative of sites taking traffic, indicative of sites not taking traffic, indicative of sites under construction, and indicative of sites planned for futuristic coverage, wherein for the coverage layer view, the user interface is further configured to:
obtain coverage information offered by the sites at each of site status; and
generate the site layer view comprising the cells in the map, wherein faulty sites are highlighted in the map.

12. The system of claim 11, wherein the user interface (206) is configured to provide at least one Key Performance Indicators (KPIs) in the map, and wherein the KPIs comprising Reference Signal Received Power (RSRP), Signal-to-Interference-plus-Noise Ratio (SINR), and throughput.

13. The system of claim 12, wherein the user interface (206) is further configured to:
receive input to generate the coverage layer views at defined schedules, and the KPIs to be generated with the coverage layer views and the site types; and
generate the scheduled coverage layer views along with the corresponding KPIs and the site types, at the defined schedules.

14. The system of claim 13, wherein the coverage layer views are automatically updated, and wherein responsive to implementation of a new site, the new site with traffic information is displayed in the coverage layer views.

15. A computer program product comprising a non-transitory computer-readable medium comprising instructions that, when executed by one or more processors, cause the one or more processors to perform a method (300) of generating a real-time view in terms of a site layer view and coverage layer view for a network, the method comprising:
storing by at least one source (160), a plurality of information corresponding to sites and coverage associated with the network;
receiving, through a user interface (152, 206), a view selection for generating the site layer view and the coverage layer view;
receiving, through the user interface (152, 206), a site status input;
response to receiving, providing through the user interface (152, 206), a technology selection option, wherein the technology selection option comprises a 4^{th} generation (4G) mobile network, a 5^{th} generation (5G) mobile network, a sixth generation (6G) mobile network, and wireless fidelity (Wi-Fi);
receiving, through the user interface (152, 206), a technology selection input from the technology selection option; and
generating, through the user interface (152, 206), at least one output in a form of a map visualization based on the plurality of information, the view selection, the site status input, and the technology selection input.

16. A user equipment (104) communicatively coupled with a system (108), the coupling comprises steps of:
receiving a connection request;
sending an acknowledgment of connection request to the system (108); and
transmitting data from a network view module (212) running in the UE (104) to the system (108), wherein the system (108) is configured for performing of generating a real-time view in terms of a site layer view and coverage layer view for a network as claimed in method of claim 1.
